(19) United States
(12) Patent Application Publication
(10) Pub. No.: US 2026/0169700 A1
(43) Pub. Date: Jun. 18, 2026

(54) TREE STRUCTURE MAXIMIZING CODE PROPERTY GRAPH INFORMATION

(71) Applicant: SAP SE, Walldorf (DE)

(72) Inventors: Rocio Cabrera Lozoya, Antibes (FR); Antonino Sabetta, Mouans Sartoux (FR); Tommaso Aiello, La Spezia (IT)

(21) Appl. No.: 18/984,395

(22) Filed: Dec. 17, 2024

(51) Int. Cl. G06F 8/30

(52) U.S. Cl. CPC G06F 8/30

(57) ABSTRACT

The disclosure generally describes methods, software, and systems for generation of code property graph trees integrating control-flow and dataflow. A code property graph (CPG) of source code is received. The CPG includes a graph representation of the source code. The CPG merges information from an abstract syntax tree (AST) of the source code and a control flow graph of the source code. The CPG includes multiple CPG edges. A CPG edge of the plurality of CPG edges is added to the AST. The CPG edge includes a directed edge identifying a target node. An AST edge connecting the target node to a root node is identified, using the CPG edge. If a removal of the AST edge retains a tree property of the AST, the AST edge connecting the target node to a parent node is removed to generate a CPG tree including AST edges and CPG edges.

### TECHNICAL FIELD

The present disclosure relates to source code analysis. More particularly, implementations of the present disclosure are directed to generation of code property graph trees by combining information from abstract syntax trees and code property graphs.

### BACKGROUND

Source code can be transformed into machine language to be interpreted by computers. The generated machine language can be provided as input to machine learning algorithms trained to analyze source code. The vast amount of source code that is constantly generated requires automated tools. Some software providing systems can frequently analyze source code to assess its performance or security. Finding the appropriate representation to be fed into a machine learning model that can maximize the utility for the task is of vital importance. Some approaches treat source code in the same manner as natural language processing (e.g., as a sequence of tokens) or rely on metadata, where there is no need for such transformation. Other approaches rely on code representations stemming from the domain of computer science (e.g. syntax trees or property graphs). The code representations can be parsed, through the extraction of paths in the graph, before being fed to neural networks for the task they aim to solve.

### SUMMARY

Implementations of the present disclosure are directed to techniques and tools for source code analysis. More particularly, implementations of the present disclosure are directed to generation of code property graph trees by combining information from abstract syntax trees and code property graphs.

In some implementations, a method includes: receiving a code property graph (CPG) of source code, the CPG including a graph representation of the source code, the CPG merging information from an abstract syntax tree (AST) of the source code and a control flow graph of the source code, the CPG including a plurality of CPG edges, adding a CPG edge of the plurality of CPG edges to the AST, the CPG edge including a directed edge identifying a target node, identifying, using the CPG edge, an AST edge connecting the target node to a root node, determining that a removal of the AST edge retains a tree property of the AST, and removing the AST edge connecting the target node to a parent node to generate a CPG tree including AST edges and CPG edges.

The foregoing and other implementations can each optionally include one or more of the following features, alone or in combination. In particular, implementations can include all of the following features:

In some aspects, combinable with any of the previous aspects, wherein determining that a removal of the AST edge retains a tree property of the AST, includes analyzing a connectivity of the target node with the root node. Analyzing a connectivity of the target node with the root node, includes determining that the root node is reachable through an updated path. The computer-implemented method includes determining that a removal of an additional AST edge, identified using an additional CPG edge, fails to retain the tree property of the AST, designating the additional CPG edge as a blocking edge, and reversing an addition of the additional CPG edge and the removal of the additional AST edge. The computer-implemented method includes determining completion of scanning of the plurality of CPG edges excluding blocking edges, and determining whether the removal of the additional AST edge, identified using the additional CPG edge retains the tree property of the AST. The computer-implemented method includes processing the CPG tree to extract a plurality of paths, each path including one or more semi paths connecting pairs of nodes. The computer-implemented method includes providing a prompt including the plurality of paths as input for a machine learning model to assess a performance or a security of the source code.

Other implementations of the aspect include corresponding systems, apparatus, and computer programs, configured to perform the actions of the methods, encoded on computer storage devices.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

These and other implementations can each optionally include one or more of the following advantages. The described implementation provides an efficient automatic generation of code property graph trees. The described implementation effectively incorporates control-flow and data-flow dimensions without losing the hierarchical structure of the tree, facilitating the capture of crucial information that abstract syntax trees cannot capture alone. The integration of control-flow and data-flow dimensions approach advantageously facilitates the analysis of complex code behaviors, such as taint propagation and conditional data dependencies. As another advantage, the described implementation preserves the tree-like structure of abstract syntax trees, facilitating the use of efficient path extraction algorithms. Unlike control flow graphs, which suffer from path explosion due to the integration of multiple graph types, the described approach ensures that path enumeration remains manageable preserving the efficiency of tree-based path extraction. As another advantage, the described implementations provide enhanced efficiency gains from unified analysis. The described implementations combine the analysis aspects in a unified structure, meaning that only a single model needs to be built and traversed. The described path extraction inherently integrates control-flow and data-flow information while maintaining the simplicity of abstract syntax tree path extraction. The described implementations eliminate the need for additional merging or correlation across separate models, reducing the computational overhead and latency associated with processing multiple models, while increasing the efficiency of the analysis with improved accuracy.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the subject matter of the specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram of an example system for generation of code property graph trees, according to some implementations of the present disclosure.

FIG. 2 is a block diagram of an example system architecture for generation of code property graph trees, according to some implementations of the present disclosure.

FIG. 3A is a block diagram of an example flow chart diagram for the code property graph tree extractor, according to some implementations of the present disclosure.

FIG. 3B is a block diagram of an example AST model used for path extraction, according to some implementations of the present disclosure.

FIG. 3C is a block diagram of an example extracted path, according to some implementations of the present disclosure.

FIG. 4 is a flowchart of an example process for generation of code property graph trees, according to some implementations of the present disclosure.

FIG. 5 is a block diagram of an exemplary computer system used to provide computational functionalities associated with described algorithms, methods, functions, processes, flows, and procedures, according to some implementations of the present disclosure.

Like reference numbers and designations in the various drawings indicate like elements.

### DETAILED DESCRIPTION

The present disclosure relates to generating a source code representation that enables machine learning (ML) applications. More particularly, implementations of the present disclosure are directed to generation of code property graph trees integrating control-flow and dataflow. A code property graph (CPG) is a graph representation of source code which merges information from its abstract syntax tree (AST), control flow graph (CFG) and program dependence graph (PDG). The unified CPG model provides the advantage of capturing most of the information that is processable to extract security properties of source code fragments. The CFG includes multiple edges that can be added to the AST and can be processed to identify AST edges connecting target nodes to root nodes. A CPG tree including AST edges and CPG edges can be generated by removing AST edges connecting target nodes to parent nodes.

ASTs are traditionally used during the syntax analysis phase of compilation to represent the structure of the source code. ASTs facilitate traversal and efficient path extraction because of the respective structures including a well-defined parent-child relationship that limits the number of possible paths. ASTs represent the syntactic structure but are limited at capturing semantic information. For example, ASTs are limited by construction, lacking control-flow and data-flow information, which are essential for detecting many security vulnerabilities. Some approaches that treat ASTs, control-flow, and dataflow separately require multiple model constructions and separate analyses, which is computationally expensive. The complexity of multi-model constructions increases with large ASTs that lead to increased memory usage and slower processing times.

Addressing the limitations of multi-model constructions, the generation of CPG trees described in the present disclosure enhance the effectiveness and efficiency of code analysis, optimizing the analysis of complex software systems. The described approach provides an efficient automatic generation of CFG trees by analyzing CFG edges that can be added to the AST, identifying AST edges connecting target nodes to root nodes. The described implementation effectively incorporates control-flow and data-flow dimensions through the CPG edges without losing the hierarchical structure of the tree, by integrating AST edges. As another advantage, the described generation of CPG trees provide enhanced processing efficiency gains from unified analysis, minimizing processing resources by generating and traversing a single model, instead of multiple models. For example, the described generation and traversal of a single model eliminates the prerequisite for additional merging or correlation across separate models, reducing the computational overhead and latency associated with processing multiple models, while increasing the efficiency of the analysis with improved accuracy.

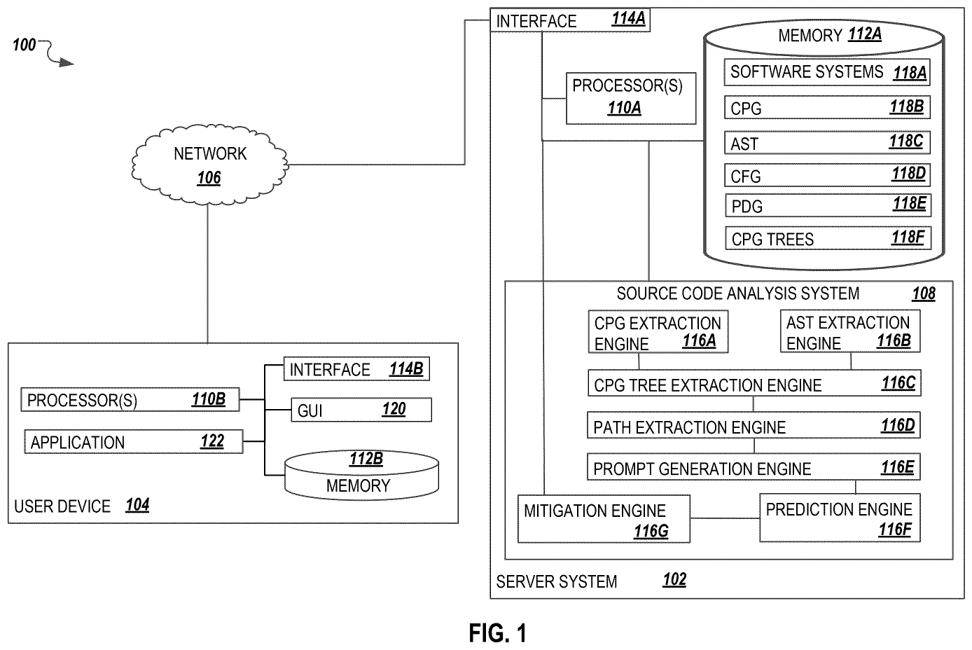

FIG. 1 is a block diagram of an example system 100 for generation of CPG trees, according to some implementations of the present disclosure. Specifically, the illustrated example system 100 includes or is communicably coupled with a server system 102, an end-user device 104, and a network 106. Although shown separately, in some implementations, functionality of two or more systems or servers can be provided by a single system or server. In some implementations, the functionality of one illustrated system, server, or component can be provided by multiple systems, servers, or components, respectively.

In the example of FIG. 1, the server system 102 is intended to represent various forms of servers including, but not limited to a web server, an application server, a proxy server, a network server, and/or a server pool. In general, server systems 102 accept requests for application services including generation of code property graph trees integrating control-flow and dataflow services and provides such services to any number of end-user devices 104 (e.g., the user device 104 over the network 106). In accordance with implementations of the present disclosure, and as noted above, the server system 102 can host a solution environment that can be a cloud environment providing software applications, systems, and services that can be consumed by customers as a service. In some instances, the server system 102 can support configuring of various tenants of different types, as well as services of different types that are integrated in customer integration scenarios and support execution of defined processes associated with generation of code property graph trees integrating control-flow and dataflow. For example, the server system 102 includes a source code analysis system 108, a processor 110A, a memory 112A, and an interface 114A.

The source code analysis system 108 can include a CPG extraction engine 116A, an AST extraction engine 116B, a CPG tree extraction engine 116C, a path extraction engine 116D, a prompt generation engine 116E, a prediction engine 116F, and a mitigation engine 116G. The source code analysis system 108 is coupled to the processor 110A, the memory 112A, and the interface 114A for generation of code property graph trees using data stored in the memory 112A. The memory 112A can include software systems 118A, CPGs 118B, ASTs 118C, CFGs 118D, PDGs 118E, and CPG trees 118F.

For example, as user devices 104 generate requests for analysis (e.g., threat modeling) of a software system 118A, the source code analysis system 108 can be used to generate CPG trees 118F for the software system 118A, using the CPG tree extraction engine 116C. The CPG tree extraction engine 116C can call the CPG extraction engine 116A and the AST extraction engine 116B to generate a respective CPG 118B and a respective AST 118C from the respective source code. The CPG extraction engine 116A can process the source code, can generate the CPG, the CFG, and the PDG. The CPG extraction engine 116A can send the generated CPG, CFG, and PDG to the CPG tree extraction engine 116C for further processing and to the memory 112A for storage. The AST extraction engine 116B can process the source code to generate the AST and can send the AST to the CPG tree extraction engine 116C for further processing and to the memory 112A for storage.

The CPG tree extraction engine 116C can process the CPG, received from the CPG extraction engine 116A, and the AST, received from the AST extraction engine 116B, to generate the CPG tree. The CPG tree extraction engine 116C can send the CPG tree to the path extraction engine 116D for further processing and to the memory 112A for storage. The path extraction engine 116D can process the CPG tree, according to a set of rules, to generate an optimized path. The path extraction engine 116D can transmit the path to the prompt generation engine 116E to generate, using vector descriptions, contexts, and a prompt template, a prompt for the prediction engine 116F. The prediction engine 116F can use a prediction model to produce textual descriptions of software system issues (e.g., threats) associated with the path corresponding to the prompt and send them to the mitigation engine 116G. The mitigation engine 116G can process the textual descriptions of the software system issues to generate a mitigation plan that can be displayed on the graphical user interface (GUI) 120 and stored in the memory 112A.

The components of the source code analysis system 108, including the prompt generation engine 116E, the prediction engine 116F, and the mitigation engine 116G can include machine learning (e.g., generative AI) functionality for optimizing generation of CPG trees. For example, the prompt generation engine 116E of the present disclosure is coupled to the interface 114A to provide an integrated user interface (UI) rendering solution within a digital assistant that leverages generative AI to infer a context of the software system 118A and optimize prompt processing for generation of an efficient mitigation plan that effectively increases a security of the software system 118A. More particularly, the source code analysis system 108 of the present disclosure calls the prompt generation engine 116E to leverage the ability of the prediction engines 116F including large language models (LLM) to generate descriptions of threats and mitigations and to automatically create a mitigation solution applicable to the target software system 118A for a particular source code modification context.

In general, the end-user device 104 includes an electronic computer device operable to receive, transmit, process, and store any appropriate data associated with the system 100 of FIG. 1. The end-user device 104 is intended to encompass any client computing device such as a laptop/notebook computer, wireless data port, smart phone, personal data assistant (PDA), tablet computing device, one or more processors within these devices, or any other suitable processing device. The end-user device 104 includes an interface 114B, a processor 110B, a memory 112B, and a GUIs 120. The end-user device 104 can include one or more applications 122. The application 122 can be any type of application that allows a user device to request and view content on the user device (e.g., generate a request for CPG tree generation). In some implementations, an application 122 can use parameters, metadata, and other data to access the source code analysis system 108 from the server system 102. In some instances, an application 122 can be an agent or client-side version of the one or more enterprise applications running on an enterprise server (not shown).

In accordance with implementations of the present disclosure, the application 122 includes a digital assistant that enables interactions with the user device 104. For example, and as described in further detail herein, the digital assistant of the user device 104 can receive a query. In some examples, one or more query responses can include data that is presented as a graphical representation in the GUI 120. In accordance with implementations of the present disclosure, the digital assistant can present data as a graphical representation in a popover container within a window therein. In some examples, the popover container is provided as an iframe-based container and the digital assistant communicates with the popover container using remote procedure calls.

As described in further detail herein, a user can input a query to the digital assistant and the digital assistant can receive a response to the query. In accordance with implementations of the present disclosure, the response can include a display of a mitigation plan. In some examples, the response can include a graphical representation of the CPG tree 118F with annotations including software system issues identified by the prediction engine 116F (e.g., LLM) in view of the context of the software system and is displayed in a UI of the digital assistant. In some examples, the graphical representation can be provided as a web-based rendering using a web rendering runtime that is built into the popover container (e.g., iframe). In some examples, the graphical representation is compatible with a UI framework of the popover container. An example UI framework includes, without limitation, SAPUI5 provided by SAP SE of Walldorf, Germany.

In some implementations, any, or all, of the components of the example system 100, both hardware or software (or a combination of hardware and software), can interface with each other or the interface(s) 114A, 114B, (or a combination of both) over the network 106 for generation of code property graph trees integrating control-flow and dataflow. The functionality of the end-user device 104 can be accessible for all service consumers using the application 122 that transmits prompts to the source code analysis system 108 to generate CPG trees 118F and mitigation plans.

For example, the end-user device 104 can include a computer that includes an input device, such as a keypad, touch screen, or other device that can accept user information, and an output device that conveys information associated with the operation of the server system 102, or the user device itself, including digital data, visual information, or a GUI 120, respectively. The GUI 120 each interface with at least a portion of the system 100 for any suitable purpose, including generating a visual representation of the application 122 or the administrative application 133, respectively. In particular, the GUI 120 can be used to view and navigate various Web pages. The GUI 120 can provide the user with an efficient and user-friendly presentation of business data provided by or communicated within the system. The GUI 120 can include a plurality of customizable frames or views having interactive fields, pull-down lists, and buttons operated by the user. The GUI 120 can include any suitable graphical user interface, such as a combination of a generic web browser, intelligent engine, and command line interface (CLI) that processes information and efficiently presents the results to the user visually.

In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems. Data exchanged over the network 106, is transferred using any number of network layer protocols, such as Internet Protocol (IP), Multiprotocol Label Switching (MPLS), Asynchronous Transfer Mode (ATM), Frame Relay, etc. Furthermore, in implementations where the network 106 represents a combination of multiple sub-networks, different network layer protocols are used at each of the underlying sub-networks. In some implementations, the network 106 represents one or more interconnected internetworks, such as the public Internet.

Each processor 110A, 110B included in the end-user device 104 can be a central processing unit (CPU), an application specific integrated circuit (ASIC), a field-programmable gate array (FPGA), or another suitable component. Each processor 110A, 110B included in the end-user device 104 executes instructions and manipulates data to perform the operations of the end-user device 104, respectively. Specifically, each processor 110A, 110B included in the end-user device 104 executes the functionality required to send requests to the server system 102 and to receive and process responses from the server system 102. Each processor 110A, 110B can be a CPU, a blade, an ASIC, a FPGA, or another suitable component. Each processor 110A, 110B executes instructions and manipulates data to perform the operations of the respective system (the server system 102, the end-user device 104). Specifically, each processor 110A, 110B executes the functionality required to receive and respond to requests from the respective system (the server system 102, the end-user device 104), for example.

Interfaces 114A, 114B are used by the server system 102, the end-user device 104, respectively, for communicating with other systems in a distributed environment - including within the system 100 - connected to the network 106. The interfaces 114A, 114B each include logic encoded in software and/or hardware in a suitable combination and operable to communicate with the network 106. More specifically, the interfaces 114A, 114B can each include software supporting one or more communication protocols associated with communications such that the network 106 or interface's hardware is operable to communicate physical signals within and outside of the illustrated system 100.

The memory 112A, 112B can include any type of memory or database module and can take the form of volatile and/or non-volatile memory including, without limitation, magnetic media, optical media, random access memory (RAM), read-only memory (ROM), removable media, or any other suitable local or remote memory component. The memory 112A, 112B can store various objects or data, including caches, classes, frameworks, applications, backup data, business objects, jobs, web pages, web page templates, database tables, database queries, repositories storing business and/or dynamic information, and any other appropriate information including any parameters, variables, algorithms, instructions, rules, constraints, or references thereto associated with the purposes of the server system 102, or the end-user device 104, respectively.

There can be any number of end-user devices 104 and API provider systems 110 associated with, or external to, the system 100. Additionally, the example system 100 can include one or more additional user devices external to the illustrated portion of system 100 that are configured to facilitate interactions with the system 100 using the network(s) 106. Further, the term “client,” “user device,” and “user” can be used interchangeably as appropriate without departing from the scope of the disclosure. Moreover, while user device can be described in terms of being used by a single user, the disclosure contemplates that many users can use one computer, or that one user can use multiple computers. As used in the present disclosure, the term “computer” is intended to encompass any suitable processing device. For example, although FIG. 1 illustrates a single server system 102, a single end-user device 104, the system 100 can be implemented using a single, stand-alone computing device, two or more servers 102, or multiple user devices. The server system 102, and the end-user device 104 can include any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the server system 102 and the end-user device 104 can be adapted to execute any operating system or runtime environment, including Linux, UNIX, Windows, Mac OS®, Java™, Android™, iOS, BSD (Berkeley Software Distribution) or any other suitable operating system. According to one implementation, the server system 102 can also include or be communicably coupled with an e-mail server, a Web server, a caching server, a streaming data server, and/or another suitable server.

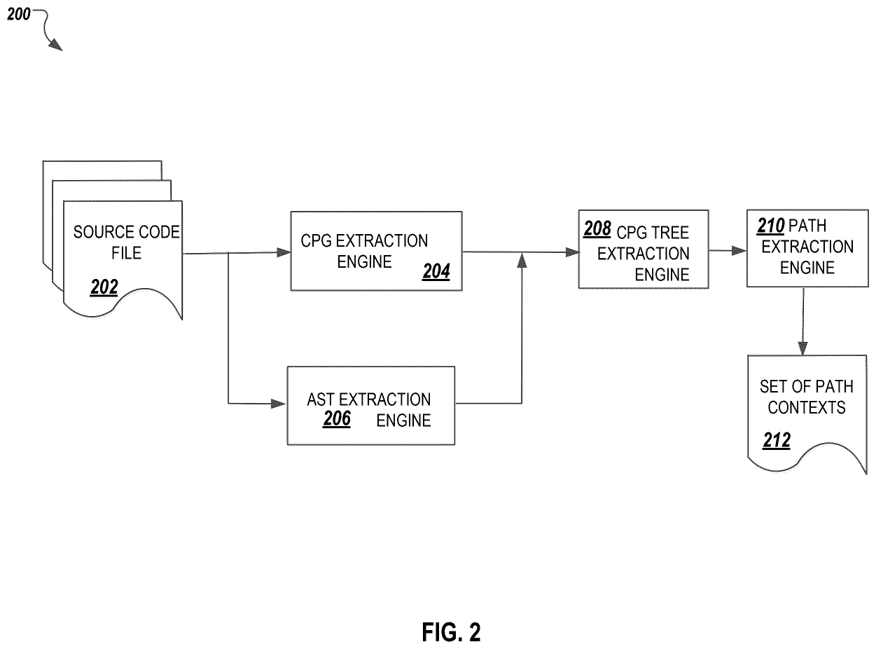

Regardless of the particular implementation, “software” can include computer-readable instructions, firmware, wired and/or programmed hardware, or any combination thereof on a tangible medium (transitory or non-transitory, as appropriate) operable when executed to perform at least the processes and operations described herein. Indeed, each software component can be fully or partially written or described in any appropriate computer language including C, C++, Java™, JavaScript®, Visual Basic, assembler, Perl®, ABAP (Advanced Business Application Programming), ABAP OO (Object Oriented), any suitable version of 4GL, as well as others. While portions of the software illustrated in FIG. 1 are shown as individual modules that implement the various features and functionality through various objects, methods, or other processes, the software can instead include multiple sub-modules, third-party services, components, libraries, and such, as appropriate. Conversely, the features and functionality of various components can be combined into single components as appropriate. The communication between the user device 104 and the server system 102 can include several different communication protocols configured to optimize generation of code property graph trees, as further described in detail with reference to FIGS. 2-5.

FIG. 2 is a block diagram of an example system architecture 200 for generation of code property graph trees, according to some implementations of the present disclosure. The example system architecture 200 includes source code files 202, a CPG extraction engine 204 (e.g., CPG extraction engine 116A described with reference to FIG. 1), an AST extraction engine 206 (e.g., AST extraction engine 116B described with reference to FIG. 1), a CPG tree extraction engine 208 (e.g., CPG tree extraction engine 116C described with reference to FIG. 1), a path extraction engine 210 (e.g., path extraction engine 116D described with reference to FIG. 1), and a set of path contexts 212.

The source code files 202 can include changed source code files of software systems or new source code files generated for the software systems (e.g., software systems 118A described with reference to FIG. 1). The changed source code files 202 refer to source code files that were previously stored in the memory and were modified. The modifications of the changed source code files 202 include additions and deletions of code segments. The modifications can range from minor changes to substantial changes, reflecting updates, bug fixes, or enhancements to the software systems. New source code files 202 are entirely new additions to the software systems, being stored in the memory, representing new features or components being integrated into the existing codebase. The setup of the memory can facilitate efficient tracking and management of changes to the source code files 202 and retrieval of the source code changes.

The CPG extraction engine 204 processes the source code files 202 and generates a respective AST representing the hierarchical structure of the source code, the CFG defining the order in which statements and instructions are executed in the source code files 202, and PDG defining dependencies between different parts of the source code files 202. The CPG extraction engine 204 merges the generated AST, CFG, and PDG at common nodes, such as statements and predicates, to form the CPG. The generated CPG is a unified graph that retains the hierarchical structure of the AST, integrating the control-flow and data-flow information from the CFG and PDG. A variety of solutions (both open source and commercial) exist for the generation of the CPG, and they can support one or multiple programming languages. The CPG extraction engine 204 can support multiple programming languages. For example, the CPG extraction engine 204 can include one or more tools designed to generate CPGs for various languages, including C/C++, JAVA, JAVASCRIPT, TYPESCRIPT, PYTHON, JOERN, and more. The multi-language support, provided by the CPG extraction engine 204 can facilitate for comprehensive code analysis across different programming environments, making it a versatile tool for security analysis.

The AST extraction engine 206 processes the source code files 202, by using a lexical analyzer that scans the source code files 202 and converts the source code into a series of tokens. The AST extraction engine 206 includes a parser that processes the tokens and arranges the tokens into a hierarchical structure based on the grammar of the programming language. The hierarchical structure generated by the AST extraction engine 206 is the AST. The AST is a tree representation of the source code files 202 including an abstract syntactic structure of the source code files 202. In some implementations, the AST extraction engine 206 includes a pruning engine and an optimization engine. The pruning engine can prune unnecessary nodes (such as redundant parentheses) of the AST to simplify the AST. The optimization engine can optimize the AST for further processing, such as code generation or analysis. The AST extraction engine 206 can include one or more AST generator tools (e.g., JOERN) that are language specific and support a number of programming languages.

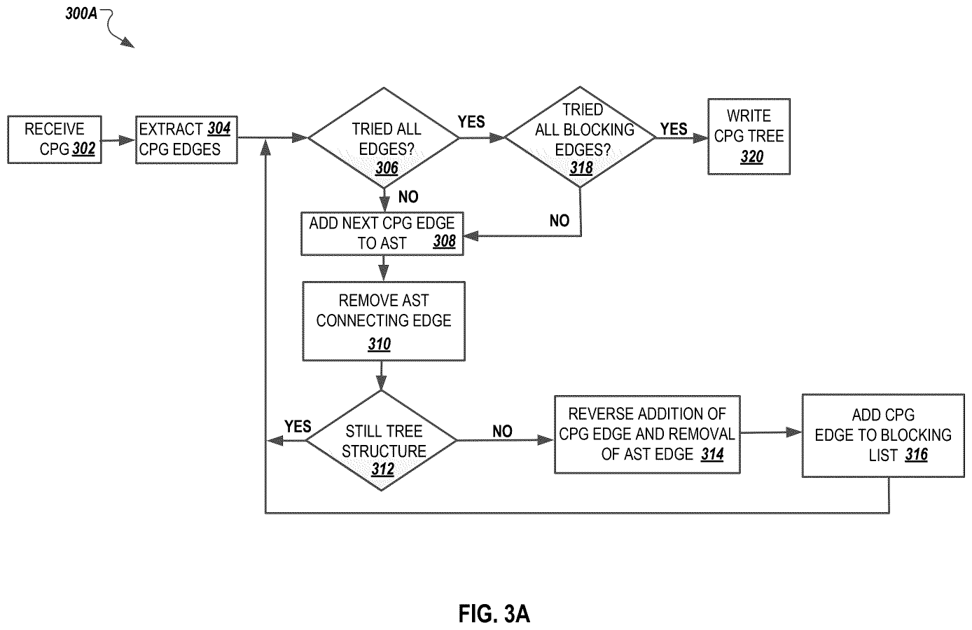

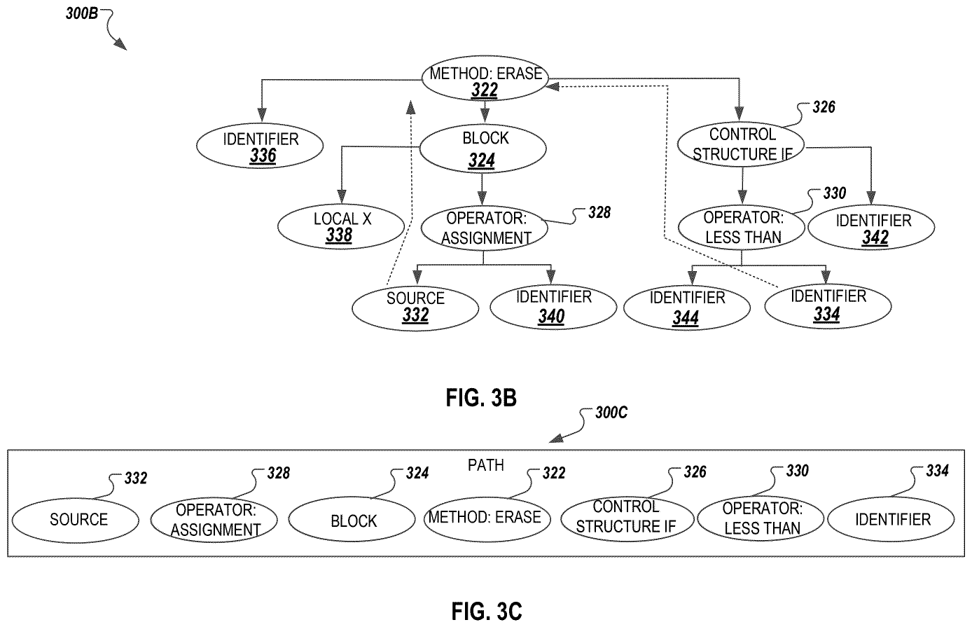

The CPG tree extraction engine 208 processes the received CPGs and ASTs to generate CPG trees. The CPG tree extraction engine 208 can generate a representation that enriches the AST with a maximum number of edges selected from the CPG, while maintaining a tree structure. To obtain the CPG tree, the CPG tree extraction engine 208 takes the AST as the starting point and adds individual CPG edges. Because the CPG edge is a directed edge, its target node can be identified and the AST edge connecting the target node to the parent node in the AST is removed. The CPG tree extraction engine 208 verifies the possible outcomes after performing the edge removal operations. If the CPG tree extraction engine 208 determines that the AST structure retains its inherent tree properties, the CPG tree extraction engine 208 completes the edge removal. If the CPG tree extraction engine 208 determines that the AST tree becomes fragmented into two distinct, disconnected trees, the insertion and deletion operations are reversed. The CPG tree extraction engine 208 verifies the possible outcomes of insertion and deletion operations by analyzing the connectivity of the modified node with the root node. If the root remains reachable, the tree structure is determined as remaining intact and the CPG tree extraction engine 208 can proceed and add a new CPG edge. In response to determining that the insertion and deletion operations are reversed, and the CPG edge is placed in a list designated for later use (called blocking edges). In response to determining that each CPG edge has been attempted for incorporation into the structure once, the set of blocking edges is re-scanned, as alterations to the original tree's configuration may facilitate the inclusion of edges previously marked as blocking edges. The CPG tree extraction engine 208 executes the process of evaluating the blocking edges until a full cycle with no new edge insertion is completed. Further details regarding the CPG tree generation process, executed by the CPG tree extraction engine 208, are provided with reference to FIG. 3A.

The path extraction engine 210 can extract fragments (e.g., semi-paths) from the CPG tree to assist the CPG tree extraction engine 208 to determine outcomes of insertion and deletion operations. The path extraction engine 210 can process the CPG tree to generate a collection of paths that correspond to connections of the possible pairs of leaves in the tree. The path extraction engine 210 can execute the path extraction using the concept of semi-paths connecting two pairs of tree leaves. Extracting paths from trees implies having a single root node, where each node has only one parent node. The path extraction requires that for a given node, the path that goes from a leaf to the root is unique and can be found by going up along the tree until the root is reached. The path extraction engine 210 can find a path between a pair of leaves, the semi-path from each leaf to the root is found and they are then combined to reconstruct the complete path. The path extraction engine 210 can extract path-contexts 212 for source code versions before and after a commit (e.g., a security-relevant commit defining security-relevant instances that can be built by mining open-source code repositories). A commit can be represented as the semantic difference of the path-contexts between the source code versions. Further details regarding the path extraction process, executed by the path extraction engine 210, are provided with reference to FIG. 3B.

FIG. 3A is a block diagram of an example data flow model 300A of an example system, according to some implementations of the present disclosure. The example data flow model 300A can be generated by a CPG tree extraction engine (e.g., CPG tree extraction engine 208, described with reference to FIG. 2). The example data flow model 300A illustrates the operations between nodes (components) of a system, such as components of a source code analysis system (e.g., source code analysis system 108 described with reference to FIG. 1) to replace AST edges with as many CPG edges as possible to generate a CPG tree.

At 302, a CPG corresponding to a source code is received. In some implementations, an AST corresponding to the same source code is received. The CPG is vectorized by determining a set of edges with a known total number of edges N. At 304, the CPG edges are extracted from the CPG one by one in an iterative manner, using an incremental counter i that increases by 1 for each verified CPG edge. At 306, it is determined whether all edges have been verified by comparing the incremental counter i to the total number of edges N.

At 308, in response to determining that one or more edges have not been verified, the incremental counter i being smaller than the total number of edges N, a next CPG edge is selected to be added to the AST. In some implementations, the CPG edge is randomly selected. The selected edge connects a new parent node to a target node.

At 310, an AST connecting edge is removed to delete a previous parent node of a target node to avoid a loop having two parent nodes connected to a target node. At 312, it is determined whether the AST still forms a tree structure if the AST connecting edge is removed. Determining whether the AST still forms a tree structure includes determining whether the root node can be reached starting from the target node according to a set direction (e.g., proceeding through the new parent node).

At 314, in response to determining that the edge removal divides the AST into multiple tree structures (the root node is unreachable starting from the target node and proceeding through the new parent node), the CPG edge addition and the edge removal are reversed.

At 316, the CPG edge corresponding to the reversing operation is added to a blocking list. After the blocking list is updated, process 300A returns to verification of the whether all edges were verified (at 306).

At 318, in response to determining that all edges have been verified, it is determined whether all blocking edges have been verified. In response to determining that one or more blocking edges remained unverified, process 300A returns to the addition of a next CPG edge to the AST (at 308). At 320, in response to determining that all blocking edges have been verified the CPG tree generation is defined as being completed.

FIG. 3B is a block diagram of an example AST model 300B used for path extraction, according to some implementations of the present disclosure. The example AST model 300B illustrates connection of a root node 322 with parent nodes 324, 326, 328, 330 and leaf nodes 332, 334. The root node 322 is the topmost node of the example AST model 300B, representing the entire source code or a major construct of the source code (e.g., a function or a class). The parent nodes 324, 326, 328, 330 are nodes of the example AST model 300B directly connected to the root node and represent major components or statements within the source code. Each parent node can have its own child nodes, forming subtrees. The leaf nodes 332, 334 terminal nodes of the example AST model 300B, including tokens that appear in the source code. For example, the leaf nodes 332, 334 represent the most basic elements of the code, such as variables, constants, or operators. The leaf nodes 332, 334 do not have any children nodes. The example AST model 300B can include additional nodes 336, 338, 340, 342. The additional nodes 336, 338, 340, 342 can include any of parent nodes and leaf nodes.

FIG. 3C is a block diagram of an example extracted path 300C, according to some implementations of the present disclosure. The example extracted path 300C can be extracted from the example AST model 300B, described with reference to FIG. 3B. The example extracted path 300C can be generated by imposing an extraction rule for having a single root node within the example extracted path 300C, where each leaf node 332, 334 has only one parent node 324, 326, 328, 330. The path extraction rule restricts connections between the nodes 322-330 to a configuration, in which for a given node, the path that goes from a leaf to the root is unique and can be found by going up along the tree (example AST model 300B) until the root is reached. The example path 300C can be extracted by finding a path between a pair of leaves, the semi-path from each leaf to the root being found and then combined to reconstruct the complete path as shown in FIG. 3C.

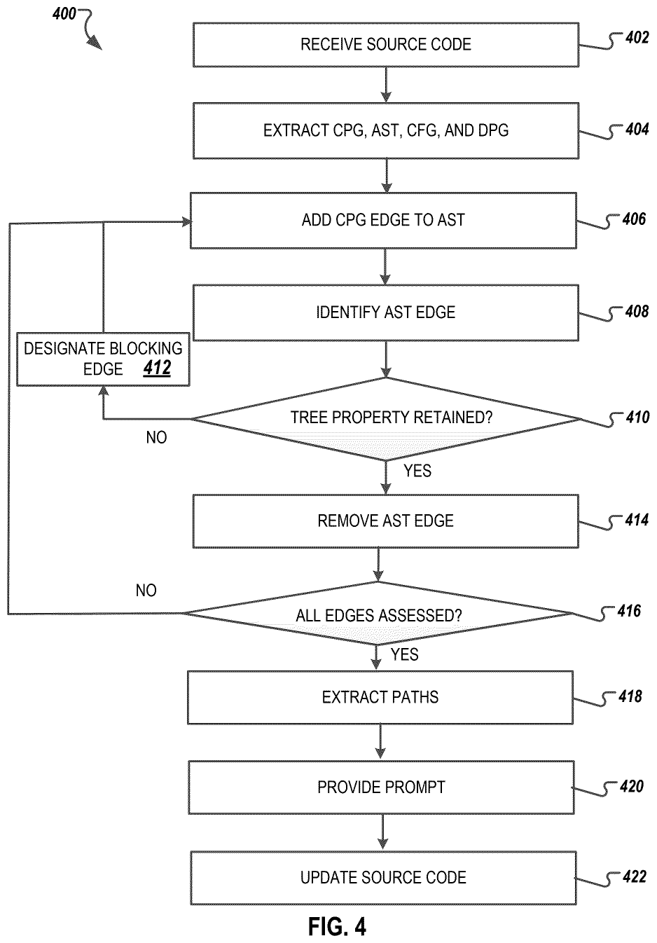

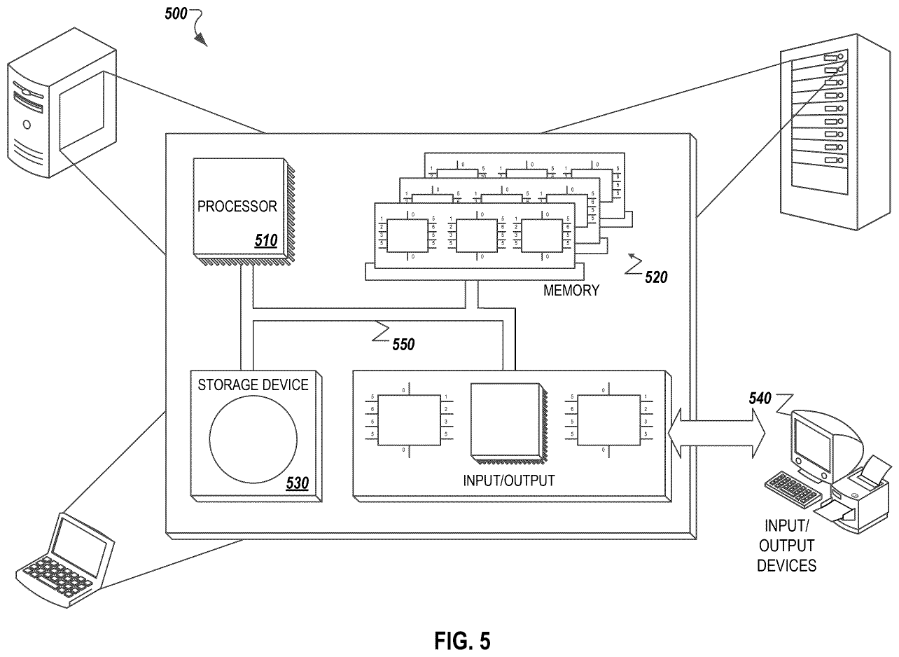

FIG. 4 is a flowchart of an example process 400 for generation of code property graph trees, according to some implementations of the present disclosure. The example process 400 can be performed by any component of the example system 100, described with reference to FIG. 1 or the example system architecture 200, described with reference to FIG. 2 or the example computing system 500, described with reference to FIG. 5. For clarity of presentation, the description that follows describes the example process 400 in the context of the systems described with reference to FIGS. 1, 2, and 5 and in the context of data flow models, such as described with reference to FIGS. 3A and 3B.

At 402, a source code is received, by one or more processors. In some implementations, the receipt of the source code includes receiving an identifier the source code to facilitate retrieval of the source code from a memory where the source code is stored. The source code can include software products (e.g., multiple open-source software (OSS) components which are built by independent software product providers). The added or modified source code can be identified for analysis to ensure the security of the software system, by surveying the security of all its components. The source code can be retrieved from repositories that present constant changes, such as addition of new functionalities, or updates targeting solutions for bugs or for fixing vulnerabilities.

At 404, CPG, AST, CFG, and PDG are extracted, by the one or more processors, from the source code. For extracting the CPG, the AST, the CFG, and the PDG, a set of nodes and tokens is generated, by the one or more processors. The tokens include pairs of connected nodes and the edges defining the connection between the nodes. The one or more edges define operations between the nodes of the respective pair of nodes. By construction, a CPG embeds the AST. For example, the set of nodes of the CPGs is identical to the set of nodes in the corresponding CPG. The set of edges of the CPG is different from the set of edges of the AST. The set of edges of the AST a strict subset of the set of edges of the CPG. For example, the set of edges of the CPG can include the set of edges of the AST and additional edges that capture control-flow and data-flow dependency among nodes. In some implementations, the CPG, the CFG, and the PDG can be extracted using a CPG extraction engine, as described with reference to FIG. 2. In some implementations, the AST, can be extracted using an AST extraction engine, as described with reference to FIG. 2.

At 406, a CPG edge of the CPG is selected to be added to the AST, by the one or more processors. The selected CPG edge can include a directed edge identifying a target node and a parent node. The CPG edge can be randomly selected or can be selected according to an edge order listing the edges of the CPG.

At 408, an AST edge of the AST is identified, by the one or more processors, for removal from the AST. The AST edge of the AST can connect the target node to a root node. The identified AST edge connects a new parent node to a target node.

At 410, it is determined, by the one or more processors, whether a tree property is retained by the addition of the CPG edge to the AST. Determining that the tree property is retained includes determining that the AST continues to form a tree structure if the AST connecting edge is removed. Conservation of the tree structure includes determining that the root node can be reached starting from the target node according to a set direction (e.g., proceeding through the new parent node).

At 412, in response to determining that the tree property fails to be retained by the addition of the CPG edge to the AST, the CPG edge is designated to be a blocking edge and the edge modification operation is reversed. The blocking edge can be added to a set of blocking edges then are verified open completion of the CPG edge verification. At 414, in response to determining that the tree property is retained by the addition of the CPG edge to the AST, the AST edge is removed, by the one or more processors.

At 416, it is determined, by the one or more processors, whether all edges were assessed. In response to determining, by the one or more processors, that one or more edges remain to be assessed, the example process 400 returns to selecting another CPG edge for addition to the AST. At 418, in response to determining, by the one or more processors, that all edges were assessed, the CPG tree is considered as being completed and paths are extracted. The CPG tree a vector representation that includes a richer source representation than offered by the extracted CPGs. Each path is a fragment of the data flow model including one or more tokens. The tokens of the extracted fragments can be concatenated according to a set of rules. The rules can limit the selection and usage of each token to at most once for a particular path. The rules can limit the tokens of a single path to be connected through a single chain of nodes without creating multiple chains of connected tokens. Each path in the set of paths corresponds to a threat applicable to a plurality of nodes within the path. In some implementations, the generation of the set of paths is reduced-by-construction, as described with reference to FIG. 3C. In some implementations, the generated set of paths is pruned (reduced) to remove a portion of the set of paths and maintain a reduced (smaller subset) of paths, according to one or more selection strategies, such as removal of sub-paths, removal of paths in the set of paths that are shorter than a threshold path length, and limiting a path length according to a set path length threshold. In some implementations, multiple paths are generated, corresponding to the versions of the source code.

At 420, a prompt is generated, by the processor for a prediction model. The prompt can be generated as a text, using one or more generated paths (e.g., paths corresponding to multiple versions of the source code) and a prompt template. For example, for each similarity search query that results in a non-empty set of triples (path, threat, mitigation), a prompt having a particular format defined by the prompt template is generated. The known threats and known mitigation can be included in the prompt as context examples that are known to exclude the potential threats corresponding to the difference between the obtained path and the similar path. In some implementations, the prompt includes as a prefix a textual content of documents from previous threat modeling analyses. to include a context in the prompt. The prompt can include a request to generate threats and mitigations for the obtained path according to the provided context. In some implementations, the prompt is validated, by the processor, by processing the one or more textual requirements. Validation of the prompt by processing the one or more textual requirements includes a verification of path and context requirements according to fields of the prompt template. The validation can be executed according to one or more conditions defining a minimum number of textual requirements to be included to enable processing of the request, such as inclusion in the request of at least one path defining nodes of a system, definition of edges between the nodes, context inclusion, at least one action, and inclusion of a request for threats and mitigation. In some implementations, in response to determining that the prompt is missing at least one textual requirement, an alert is displayed by a graphical user interface of the user device requesting the missing textual requirement. The request for the missing textual requirement can include an example of an acceptable type of textual requirement. A list of threats and a mitigation plan is received from the prediction model, in response to processing the prompt. The prediction model can include an artificial intelligence model, such as LLMs (e.g., deep learning models) trained using mitigated threats mapped to node settings. The prediction model can be trained, including an adjustment of weights according to different system types or path types, for threat modeling. The prediction model can facilitate threat analysis for intricate path patterns. The list of threats and the mitigation plan can be received as textual content and graphical content. The graphical content can include a representation of the data flow model corresponding to the analyzed system and annotated threats and mitigations. The graphical content can be displayed by a GUI of a user device. In some examples, the graphical representation can be provided as a web-based rendering using a web rendering runtime that is built into the popover container (e.g., iframe). In some examples, the graphical representation is compatible with a UI framework of the popover container. The mitigation plan can be provided as a set of recommendations or instructions for changes in the system design.

At 422, the source code is updated, by the one or more processors. For example, a mitigation plan is automatically executed. The mitigation plan can include a modification of a setting of a node of the system (e.g., activation of a firewall) and/or an adjustment of data flow according to a secure sequence of data transmission between the system nodes to perform actions involving the analyzed path. The data flow can be defined by templates indicating which components can be added. The templates can correspond to particular security communication scenarios. An application invoking a sequence of the adjusted data flow can be executed. The execution of the data flow can include retrieval of one or more APIs in the sequence of APIs from a database. The execution of the application can include generating a new API to be included in the sequence of APIs. The execution of the application can include generating an artifact matching the sequence of APIs. The execution of the application can include code generation for connection to the selected APIs to generate the data flow. The output of the automatically embed API calls in source code can be displayed by a graphical user interface.

The example process 400 for generation of code property graph trees provides an advantage of generating CPG trees that facilitate analysis for identification of relevant source code issues, such as relevant threats and mitigation plans for software systems. The example process 400 provides an efficient way to analyze code changes (commits) to determine if a given change in a repository is benign or if the change includes security issues that require a quick response to preserve system security. The example process 400 can be executed as a time-sensitive operation, to provide ample time to migrate to an updated version of the software package and to minimize the time window when malicious actors can attack an unpatched deployed component.

The described example process 400 can be used for commit analysis to solve the described security task. Using described example process 400, a set of CPG trees can be created for the version of the source code before a commit and one for the version after the commit. The described example process 400 integrates a deeper understanding of source codes using a vectorization strategy that generates a single tree-based structure combining information from the AST and CPG. The example process 400 contains syntactic, control flow and data dependency information within a tree structure which facilitates a more efficient and simplified parsing compared to traditional isolated AST graphs. The CPG trees are then parsed, and path-contexts are extracted for both versions. A commit can then be represented as the semantic difference of the path-contexts between the two versions. With a sufficiently large corpus of commits to be used as a training dataset, a neural network can be trained to classify code changes as vulnerability-fixing or not based on the path-contexts extracted from the CPG tree representation. The output of the classifier can be used to assess if it is the software code changes in the project dependencies compromise the security of the product or not. The example process 400 is applicable to multiple internal and external system types and/or versions to provide a thorough assessment of source code based on CPG trees.

FIG. 5 is a block diagram of an example computing system 500 used to provide computational functionalities associated with described algorithms, methods, functions, processes, flows, and procedures, according to some implementations of the present disclosure. As shown in FIG. 5, the computing system 500 can include a processor 510, a memory 520, a storage device 530, and input/output devices 540. The processor 510, the memory 520, the storage device 530, and the input/output devices 540 can be interconnected using a system bus 550. The processor 510 is capable of processing instructions for execution within the computing system 500. Such executed instructions can implement one or more components of, for example, the source code analysis system 108, described with reference to FIG. 1. In some implementations of the current subject matter, the processor 510 can be a single-threaded processor. Alternately, the processor 510 can be a multi-threaded processor. The processor 510 is capable of processing instructions stored in the memory 520 and/or on the storage device 530 to display graphical information for a user interface provided using the input/output device 540.

The memory 520 is a computer readable medium such as volatile or non-volatile that stores information within the computing system 500. The memory 520 can store data structures representing configuration object databases, for example. The storage device 530 can provide persistent storage for the computing system 500. The storage device 530 can be a floppy disk device, a hard disk device, an optical disk device, or a tape device, or other suitable persistent storage means. The input/output device 540 provides input/output operations for the computing system 500. In some implementations of the current subject matter, the input/output device 540 includes a keyboard and/or pointing device. In various implementations, the input/output device 540 includes a display unit for displaying graphical user interfaces.

According to some implementations of the current subject matter, the input/output device 540 can provide input/output operations for a network device. For example, the input/output device 540 can include Ethernet ports or other networking ports to communicate with one or more wired and/or wireless networks (e.g., a LAN, a WAN, the Internet).

In some implementations of the current subject matter, the computing system 500 can be used to execute various interactive computer software applications that can be used for organization, analysis and/or storage of data in various (e.g., tabular) format (e.g., Microsoft Excel®, and/or any other type of software). Alternatively, the computing system 500 can be used to execute any type of software applications. These applications can be used to perform various functionalities, e.g., planning functionalities (e.g., generating, managing, editing of spreadsheet documents, word processing documents, and/or any other objects), computing functionalities, or communications functionalities. The applications can include various add-in functionalities (e.g., SAP Integrated Business Planning add-in for Microsoft Excel as part of the SAP Business Suite, as provided by SAP SE, Walldorf, Germany) or can be standalone computing products and/or functionalities. Upon activation within the applications, the functionalities can be used to generate the user interface provided using the input/output device 540. The user interface can be generated and presented to a user by the computing system 500 (e.g., on a computer screen monitor).

One or more aspects or features of the subject matter described herein can be realized in digital electronic circuitry, integrated circuitry, specially designed ASICs, FPGAs computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input. Other input devices include touch screens or other touch-sensitive devices such as single or multi-point resistive or capacitive track pads, voice recognition hardware and software, optical scanners, optical pointers, digital image capture devices and associated interpretation software, and the like.

The preceding figures and accompanying description illustrate example processes and computer implementable techniques. The environments and systems described above (or their software or other components) can contemplate using, implementing, or executing any suitable technique for performing these and other tasks. It will be understood that these processes are for illustration purposes only and that the described or similar techniques can be performed at any appropriate time, including concurrently, individually, in parallel, and/or in combination. In addition, many of the operations in these processes can take place simultaneously, concurrently, in parallel, and/or in different orders than as shown. Moreover, processes can have additional operations, fewer operations, and/or different operations, so long as the methods remain appropriate.

In other words, although the disclosure has been described in terms of certain implementations and associated methods, alterations and permutations of these implementations, and methods will be apparent to those skilled in the art. Accordingly, the above description of example implementations does not define or constrain the disclosure. Other changes, substitutions, and alterations are also possible without departing from the spirit and scope of the disclosure.

A number of implementations of the present disclosure have been described. Nevertheless, it will be understood that various modifications can be made without departing from the spirit and scope of the present disclosure. Accordingly, other implementations are within the scope of the following claims.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.

Example 1. A computer-implemented method, comprising: receiving a code property graph (CPG) of source code, the CPG comprising a graph representation of the source code, the CPG merging information from an abstract syntax tree (AST) of the source code and a control flow graph of the source code, the CPG comprising a plurality of CPG edges; adding a CPG edge of the plurality of CPG edges to the AST, the CPG edge comprising a directed edge identifying a target node; identifying, using the CPG edge, an AST edge connecting the target node to a root node; determining that a removal of the AST edge retains a tree property of the AST; and removing the AST edge connecting the target node to a parent node to generate a CPG tree comprising AST edges and CPG edges.

Example 2. The computer-implemented method of the preceding example, wherein determining that a removal of the AST edge retains a tree property of the AST, comprises: analyzing a connectivity of the target node with the root node.

Example 3. The computer-implemented method of any of the preceding examples, wherein analyzing a connectivity of the target node with the root node, comprises: determining that the root node is reachable through an updated path.

Example 4. The computer-implemented method of any of the preceding examples, comprising: determining that a removal of an additional AST edge, identified using an additional CPG edge, fails to retain the tree property of the AST; designating the additional CPG edge as a blocking edge; and reversing an addition of the additional CPG edge and the removal of the additional AST edge.

Example 5. The computer-implemented method of any of the preceding examples, comprising: determining completion of scanning of the plurality of CPG edges excluding blocking edges; and determining whether the removal of the additional AST edge, identified using the additional CPG edge retains the tree property of the AST.

Example 6. The computer-implemented method of any of the preceding examples, comprising: processing the CPG tree to extract a plurality of paths, each path comprising one or more semi paths connecting pairs of nodes.

Example 7. The computer-implemented method of any of the preceding examples, comprising: providing a prompt comprising the plurality of paths as input for a machine learning model to assess a performance or a security of the source code.

Example 8. a computer-implemented system, comprising: a computing device; and a computer-readable storage device coupled to the computing device and having instructions stored thereon which, when executed by the computing device, cause the computing device to perform operations for selectively generating graphical representations with digital assistants in enterprise systems, the operations comprising: receiving a code property graph (CPG) of source code, the CPG comprising a graph representation of the source code, the CPG merging information from an abstract syntax tree (AST) of the source code and a control flow graph of the source code, the CPG comprising a plurality of CPG edges; adding a CPG edge of the plurality of CPG edges to the AST, the CPG edge comprising a directed edge identifying a target node; identifying, using the CPG edge, an AST edge connecting the target node to a root node; determining that a removal of the AST edge retains a tree property of the AST; and removing the AST edge connecting the target node to a parent node to generate a CPG tree comprising AST edges and CPG edges.

Example 9. The computer-implemented system of any of the preceding examples, wherein determining that a removal of the AST edge retains a tree property of the AST, comprises: analyzing a connectivity of the target node with the root node.

Example 10. The computer-implemented system of any of the preceding examples, wherein analyzing a connectivity of the target node with the root node, comprises: determining that the root node is reachable through an updated path.

Example 11. The computer-implemented system of any of the preceding examples, the operations comprising: determining that a removal of an additional AST edge, identified using an additional CPG edge, fails to retain the tree property of the AST; designating the additional CPG edge as a blocking edge; and reversing an addition of the additional CPG edge and the removal of the additional AST edge.

Example 12. The computer-implemented system of any of the preceding examples, the operations comprising: determining completion of scanning of the plurality of CPG edges excluding blocking edges; and determining whether the removal of the additional AST edge, identified using the additional CPG edge retains the tree property of the AST.

Example 13. The computer-implemented system of any of the preceding examples, the operations comprising: processing the CPG tree to extract a plurality of paths, each path comprising one or more semi paths connecting pairs of nodes.

Example 14. The computer-implemented system of o any of the preceding examples, the operations comprising: providing a prompt comprising the plurality of paths as input for a machine learning model to assess a performance or a security of the source code.

Example 15. a Non-transitory computer-readable media encoded with a computer program, the computer program comprising instructions that when executed by one or more computers cause the one or more computers to perform operations comprising: receiving a code property graph (CPG) of source code, the CPG comprising a graph representation of the source code, the CPG merging information from an abstract syntax tree (AST) of the source code and a control flow graph of the source code, the CPG comprising a plurality of CPG edges; adding a CPG edge of the plurality of CPG edges to the AST, the CPG edge comprising a directed edge identifying a target node; identifying, using the CPG edge, an AST edge connecting the target node to a root node; determining that a removal of the AST edge retains a tree property of the AST; and removing the AST edge connecting the target node to a parent node to generate a CPG tree comprising AST edges and CPG edges.

Example 16. The non-transitory computer-readable media of the preceding example, wherein determining that a removal of the AST edge retains a tree property of the AST, comprises: analyzing a connectivity of the target node with the root node.

Example 17. The non-transitory computer-readable media of any of the preceding examples, wherein analyzing a connectivity of the target node with the root node, comprises: determining that the root node is reachable through an updated path.

Example 18. The non-transitory computer-readable media of any of the preceding examples, the operations comprising: determining that a removal of an additional AST edge, identified using an additional CPG edge, fails to retain the tree property of the AST; designating the additional CPG edge as a blocking edge; and reversing an addition of the additional CPG edge and the removal of the additional AST edge.

Example 19. The non-transitory computer-readable media of any of the preceding examples, the operations comprising: processing the CPG tree to extract a plurality of paths, each path comprising one or more semi paths connecting pairs of nodes.

Example 20. The non-transitory computer-readable media of any of the preceding examples, the operations comprising: providing a prompt comprising the plurality of paths as input for a machine learning model to assess a performance or a security of the source code.

What is claimed is:

1. A computer-implemented method, comprising:
receiving a code property graph (CPG) of source code, the CPG comprising a graph representation of the source code, the CPG merging information from an abstract syntax tree (AST) of the source code and a control flow graph of the source code, the CPG comprising a plurality of CPG edges;
adding a CPG edge of the plurality of CPG edges to the AST, the CPG edge comprising a directed edge identifying a target node;
identifying, using the CPG edge, an AST edge connecting the target node to a root node;
determining that a removal of the AST edge retains a tree property of the AST; and
removing the AST edge connecting the target node to a parent node to generate a CPG tree comprising AST edges and CPG edges.

2. The computer-implemented method of claim 1, wherein determining that a removal of the AST edge retains a tree property of the AST, comprises:
analyzing a connectivity of the target node with the root node.

3. The computer-implemented method of claim 2, wherein analyzing a connectivity of the target node with the root node, comprises:
determining that the root node is reachable through an updated path.

4. The computer-implemented method of claim 1, comprising:
determining that a removal of an additional AST edge, identified using an additional CPG edge, fails to retain the tree property of the AST;
designating the additional CPG edge as a blocking edge; and
reversing an addition of the additional CPG edge and the removal of the additional AST edge.

5. The computer-implemented method of claim 4, comprising:
determining completion of scanning of the plurality of CPG edges excluding blocking edges; and
determining whether the removal of the additional AST edge, identified using the additional CPG edge retains the tree property of the AST.

6. The computer-implemented method of claim 1, comprising:
processing the CPG tree to extract a plurality of paths, each path comprising one or more semi paths connecting pairs of nodes.

7. The computer-implemented method of claim 6, comprising:
providing a prompt comprising the plurality of paths as input for a machine learning model to assess a performance or a security of the source code.

8. A computer-implemented system, comprising:
a computing device; and
a computer-readable storage device coupled to the computing device and having instructions stored thereon which, when executed by the computing device, cause the computing device to perform operations for selectively generating graphical representations with digital assistants in enterprise systems, the operations comprising:
receiving a code property graph (CPG) of source code, the CPG comprising a graph representation of the source code, the CPG merging information from an abstract syntax tree (AST) of the source code and a control flow graph of the source code, the CPG comprising a plurality of CPG edges;
adding a CPG edge of the plurality of CPG edges to the AST, the CPG edge comprising a directed edge identifying a target node;
identifying, using the CPG edge, an AST edge connecting the target node to a root node;
determining that a removal of the AST edge retains a tree property of the AST; and
removing the AST edge connecting the target node to a parent node to generate a CPG tree comprising AST edges and CPG edges.

9. The computer-implemented system of claim 8, wherein determining that a removal of the AST edge retains a tree property of the AST, comprises:
analyzing a connectivity of the target node with the root node.

10. The computer-implemented system of claim 9, wherein analyzing a connectivity of the target node with the root node, comprises:
determining that the root node is reachable through an updated path.

11. The computer-implemented system of claim 8, the operations comprising:
determining that a removal of an additional AST edge, identified using an additional CPG edge, fails to retain the tree property of the AST;
designating the additional CPG edge as a blocking edge; and
reversing an addition of the additional CPG edge and the removal of the additional AST edge.

12. The computer-implemented system of claim 11, the operations comprising:
determining completion of scanning of the plurality of CPG edges excluding blocking edges; and
determining whether the removal of the additional AST edge, identified using the additional CPG edge retains the tree property of the AST.

13. The computer-implemented system of claim 8, the operations comprising:
processing the CPG tree to extract a plurality of paths, each path comprising one or more semi paths connecting pairs of nodes.

14. The computer-implemented system of claim 13, the operations comprising:
providing a prompt comprising the plurality of paths as input for a machine learning model to assess a performance or a security of the source code.

15. A non-transitory computer-readable media encoded with a computer program, the computer program comprising instructions that when executed by one or more computers cause the one or more computers to perform operations comprising:
receiving a code property graph (CPG) of source code, the CPG comprising a graph representation of the source code, the CPG merging information from an abstract syntax tree (AST) of the source code and a control flow graph of the source code, the CPG comprising a plurality of CPG edges;
adding a CPG edge of the plurality of CPG edges to the AST, the CPG edge comprising a directed edge identifying a target node;
identifying, using the CPG edge, an AST edge connecting the target node to a root node;
determining that a removal of the AST edge retains a tree property of the AST; and
removing the AST edge connecting the target node to a parent node to generate a CPG tree comprising AST edges and CPG edges.

16. The non-transitory computer-readable media of claim 15, wherein determining that a removal of the AST edge retains a tree property of the AST, comprises:
analyzing a connectivity of the target node with the root node.

17. The non-transitory computer-readable media of claim 16, wherein analyzing a connectivity of the target node with the root node, comprises:
determining that the root node is reachable through an updated path.

18. The non-transitory computer-readable media of claim 15, the operations comprising:
determining that a removal of an additional AST edge, identified using an additional CPG edge, fails to retain the tree property of the AST;
designating the additional CPG edge as a blocking edge; and
reversing an addition of the additional CPG edge and the removal of the additional AST edge.

19. The non-transitory computer-readable media of claim 15, the operations comprising:
processing the CPG tree to extract a plurality of paths, each path comprising one or more semi paths connecting pairs of nodes.

20. The non-transitory computer-readable media of claim 19, the operations comprising:
providing a prompt comprising the plurality of paths as input for a machine learning model to assess a performance or a security of the source code.
